(19) United States
(12) Patent Application Publication
(10) Pub. No.: US 2008/0106211 A1
(43) Pub. Date: May 8, 2008

(54) Scan electrode Driver for plasma display device

(76) Inventors: Myoung-Kyu Lee, Suwon-si (KR); Young-Jun Jeon, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/822,613

(22) Filed: Jul. 9, 2007

(30) Foreign Application Priority Data
Nov. 2, 2006 (KR) 10-2006-0107997

(51) Int. Cl. G09G 3/28; H01J 17/49

(52) U.S. Cl. 315/169.4

(57) ABSTRACT

A scan electrode driver for a plasma display device may include a set up voltage source that outputs a set up voltage, a rising ramp waveform generator that generates a rising ramp waveform in response to the set up voltage received from the set up voltage source and applies the rising ramp waveform to the plasma display panel, and a block unit arranged between the rising ramp waveform generator and one of the set up voltage source and the plasma display panel.

### BACKGROUND OF THE INVENTION

1. Field of the Invention

Embodiments of the invention relate to a plasma display device. More particularly, embodiments of the present invention relate to a scan electrode driver that provides scan signals to a plurality of scan electrodes included in a plasma display panel.

2. Description of the Related Art

A plasma display device generally includes a plasma display panel for displaying an image. Plasma display panels generally include a plurality of address electrodes, a plurality of scan electrodes, and a plurality of sustain electrodes. Plasma display devices also generally include an address driver that drives the plurality of address electrodes, a scan driver that drives the plurality of the scan electrodes, and a sustain driver that drives the plurality of sustain electrodes.

The scan driver may include an energy recovery unit, a rising ramp waveform generator, and a set-up voltage source, which may together generate a rising ramp waveform.

The energy recovery unit may supply a first set-up voltage Vs1 to the plasma display panel. As a result, a scan signal may rise to the first set-up voltage level Vs1 from a ground voltage Vg.

The rising ramp waveform generator may apply a second set-up voltage Vs2, which may be received from the set-up voltage source, to the plasma display panel. More particularly, the rising ramp waveform generator may output the second set-up voltage Vs2 after the respective scan signal has been risen to the first set-up voltage Vs1 from the ground voltage Vg, and thus, the scan signal may further rise to a ramp voltage level Vset, i.e., a voltage level equal to the sum of the first set-up voltage Vs1 and the second set-up voltage Vs2.

In conventional scan drivers, the rising ramp waveform generator may be directly connected between the set-up voltage source and an output of the energy recovery unit, and thus, a current caused by a potential difference between the second set-up voltage Vs2 and the first set-up voltage Vs1 may flow in electronic devices included in the rising ramp waveform generator. When there is a large potential difference between the second set-up voltage Vs2 and the first set-up voltage Vs1, a large amount of current may flow in the rising ramp waveform generator. In such cases, a lot of heat may be generated from the electronic devices included in the rising ramp waveform generator. Such heat may reduce the reliability of the electronic devices of the rising ramp waveform generator and/or the scan driver, and may eventually reduce the reliability of the plasma display device.

### SUMMARY OF THE INVENTION

The present invention is therefore directed to a scan electrode driver, which substantially overcomes one or more of the problems due to the limitations and disadvantages of the related art.

It is therefore a feature of an embodiment of the present invention to provide a scan electrode driver that can reduce heat generation by electronic devices included in a rising ramp waveform generator of a plasma display device.

At least one of the above and other features and advantages of the present invention may be realized by providing a scan electrode driver for a plasma display device, the scan electrode driver supplying a rising ramp waveform to a plurality of scan electrodes of a plasma display panel, the scan electrode driver including a set up voltage source adapted to output a set up voltage, a rising ramp waveform generator adapted to generate a rising ramp waveform in response to the set up voltage received from the set up voltage source and apply the rising ramp waveform to the plasma display panel, and a block unit arranged between the rising ramp waveform generator and one of the set up voltage source and the plasma display panel.

The block unit may be arranged between the rising ramp waveform generator and the set up voltage source, may be directly connected to the rising ramp waveform generator, and may be adapted to controllably block current flow from the rising ramp waveform generator to the set up voltage source. The block unit may include a diode having an anode connected to the set up voltage source, and a cathode connected to the rising ramp waveform generator. The rising ramp waveform generator may include a gate driver adapted to output a voltage of a predetermined level, a transistor having a drain connected to the block unit, a gate connected to the gate driver, and a source that outputs the rising ramp waveform, a resistance unit connected to the block unit, and a capacitor connected to the resistance unit and the transistor, and determines a rising slope of the rising ramp waveform together with the resistance unit.

The resistance unit may be at least one of a diode and a transistor. The transistor may be an N channel MOSFET that is operated when a voltage applied to the gate is higher than a voltage applied to the source. The scan electrode driver may further include an energy recovery unit connected to an output unit of the rising ramp waveform generator and may be adapted to generate a medium voltage of the rising ramp waveform. The energy recovery unit may be adapted to generate the medium voltage of the rising ramp waveform in response to a voltage received from the set up voltage source connected to the rising ramp waveform generator.

The block unit may be a diode. The block unit may be arranged between the rising ramp waveform generator and the plasma display panel, and may be adapted to controllably block current flow due to an externally supplied voltage to a node between the block unit and the plasma display panel.

The block unit may include a diode having an anode that is connected to the output unit of the rising ramp waveform generator and a cathode that is connected to the node. The rising ramp waveform generator may include a gate driver adapted to output a voltage of a predetermined level, a transistor having a drain connected to the set up voltage source, a gate connected to the gate driver, and a source that outputs the rising ramp waveform, a resistance unit connected to the set up voltage source, and a capacitor connected to the resistance unit and the MOSFET, and determines the rising slope of the rising ramp waveform together with the resistance unit.

The resistance unit may be at least one of a diode and a transistor. The transistor may be an N channel MOSFET that is operated when a voltage applied to the gate is higher than a voltage applied to the source. The scan electrode driver may further include an energy recovery unit connected to the node and generates a medium voltage of the rising ramp waveform. The energy recovery unit may be adapted to generate the medium voltage of the rising ramp waveform in response to a voltage received from the set up voltage source connected to the rising ramp waveform generator.

At least one of the above and other features and advantages of the present invention may be separately realized by providing a scan electrode driver for a plasma display device, the scan electrode driver supplying a rising ramp waveform to a plurality of scan electrodes of a plasma display panel, the scan electrode driver may include a set up voltage source adapted to output a set up voltage, a rising ramp waveform generator adapted to generate and output a rising ramp waveform at a first terminal thereof in response to the set up voltage supplied to a second terminal of the rising ramp waveform generator from the set up voltage source and apply the rising ramp waveform to the plasma display panel, and a potential difference reducing mechanism for reducing a potential difference between the first terminal and the second terminal of the rising ramp waveform generator.

The potential difference reducing mechanism may include a diode directly connected to at least one of the first terminal and the second terminal of the rising ramp waveform generator. The potential difference reducing mechanism may be a diode directly connected to at least one of the first terminal and the second terminal of the rising ramp waveform generator.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a block diagram of a scan electrode driver, according to an exemplary embodiment of the present invention, connected to a plasma display panel;

FIG. 2 illustrates a waveform of a scan signal output from the scan electrode driver of FIG. 1, according to an exemplary embodiment of the present invention;

FIG. 3 illustrates a circuit diagram of a rising ramp waveform generator employable by the scan electrode driver of FIG. 1, according to an exemplary embodiment of the present invention; and

FIG. 4 illustrates a block diagram of a scan electrode driver, according to another exemplary embodiment of the present invention, connected to a plasma display panel.

### DETAILED DESCRIPTION OF THE INVENTION

Korean Patent Application No. 10-2006-0107997, filed on Nov. 2, 2006, in the Korean Intellectual Property Office, and entitled: “Scan Electrode Driver for Plasma Display Device,” is incorporated by reference herein in its entirety.

The present invention will now be described more fully with reference to the accompanying drawings in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures and throughout the specification, like reference numerals refer to the like elements.

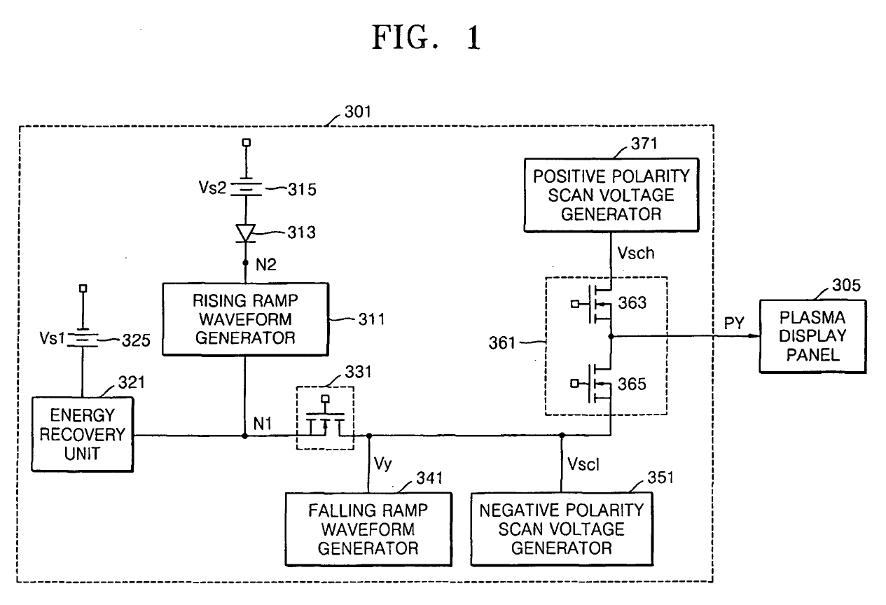

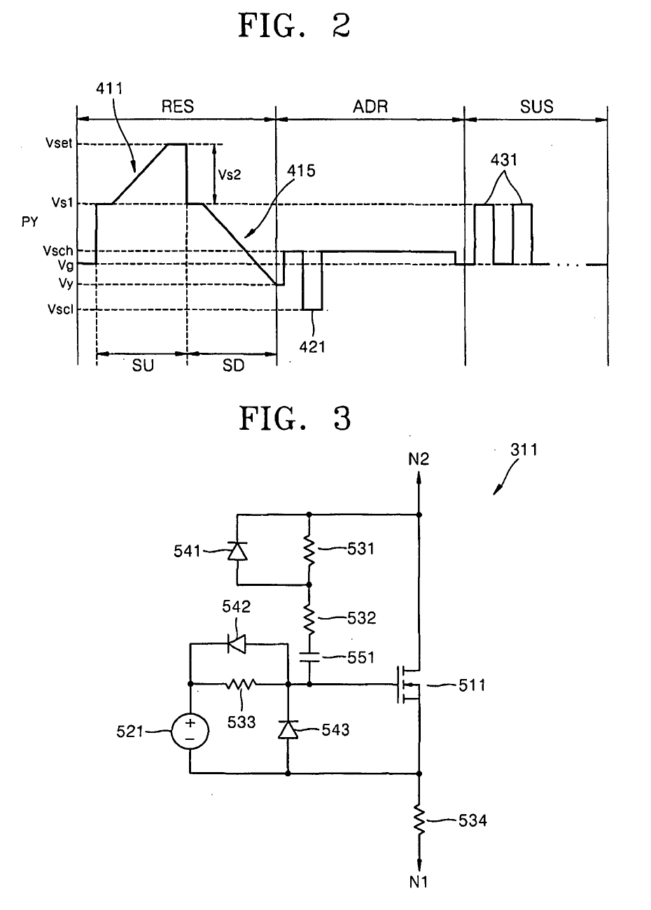

FIG. 1 illustrates a block diagram of a scan electrode driver 301, according to an exemplary embodiment of the present invention, connected to a plasma display panel 305 of a plasma display device, and FIG. 2 illustrates a waveform of an exemplary scan signal PY that may be output from the scan electrode driver 301 of FIG. 1, according to an exemplary embodiment of the present invention.

Referring to FIG. 1, the scan electrode driver 301 may include first and second set up voltage sources 325 and 315, a rising ramp waveform generator 311, a block unit 313, an energy recovery unit 321, a switching unit 331, a falling ramp waveform generator 341, a negative polarity scan voltage generator 351, a positive polarity scan voltage generator 371, and an output unit 361. The scan electrode driver 301 may generate scan signals PY and may apply the scan signals PY to the plasma display panel 305.

The rising ramp waveform generator 311 may be arranged between the block unit 313 and a node N1. Referring to FIGS. 1 and 2, the rising ramp waveform generator 311 may receive a second set up voltage Vs2 from the second set up voltage source 315 and may generate at least a portion of a rising ramp waveform 411 based on the second set up voltage Vs2. For example, during a reset period RES, the rising ramp waveform generator 311 may raise the voltage of the rising ramp waveform 411 from a first set up voltage Vs1 to the second set up voltage Vs2, where the second set up voltage Vs2 is greater than the first set up voltage Vs1. The rising ramp waveform 411 may be supplied to the plasma display panel 305.

The block unit 313 may be arranged between the rising ramp waveform generator 311 and the second set up voltage source 315. The block unit 313 may include a diode with an anode connected to the second set up voltage source 315 and a cathode connected to the rising ramp waveform generator 311. Embodiments of the invention are not limited to the block unit 313 including a diode. For example, the block unit 313 may include, e.g., a metal oxide semiconductor field effect transistor (MOSFET) instead of a diode. The block unit 313 may block the flow of a current from the rising ramp waveform generator 311 to the second set up voltage source 315.

Referring to FIGS. 1 and 2, the energy recovery unit 321 may be connected to the node N1, and may generate at least another portion of the rising ramp waveform 411 based on the first set up voltage Vs1 received from the first set up voltage source 325. For example, during the reset period RES, the energy recovery unit 321 may raise a voltage of the rising ramp waveform 411 from a ground voltage Vg to the first set up voltage Vs1, e.g., a medium voltage Vs1 of the rising ramp waveform 411. The energy recovery unit 321 may accumulate voltages output from the plasma display panel 305. During a sustain period SUS, the energy recovery unit 321 may supply the accumulated voltages to the plasma display panel 305 in an amount equal to about half of a sustain voltage. The sustain voltage may correspond to a voltage required for the plasma display panel 305 to generate sustain pulses 431 when the scan electrode driver 301 is about to generate the sustain pulses 431 during the sustain period SUS. That is, the energy recovery unit 321 may enable voltages output from the plasma display panel 305 to be reused, i.e., not wasted, thereby increasing energy efficiency of the plasma display device. In some embodiments of the invention, the sustain voltage may correspond to the first set up voltage Vs1.

In some embodiments of the invention, the first and second set up voltage sources 325 and 315 may be a single source, and such embodiments may benefit from a reduced number of voltage sources, a smaller sized scan electrode driver 301 and/or reduced manufacturing costs of the plasma display device.

The switching unit 331 may control the application of output signals generated from the rising ramp waveform generator 311 to the plasma display panel 305, and may also provide a connection path between the energy recovery unit 321 and the plasma display panel 305. The switching unit 331 may include, e.g., an N channel MOSFET.

Referring still to FIGS. 1 and 2, the falling ramp waveform generator 341 may transform the rising ramp waveform 411 into a falling ramp waveform 415 during a predetermined period of time after the rising ramp waveform 411 is output from the rising ramp waveform generator 311. That is, e.g., the falling ramp waveform generator 341 may output a set down voltage Vy, and may transform the rising ramp waveform 411 into the falling ramp waveform 415 by supplying the set down voltage Vy to the plasma display panel 305 during a portion of the reset period RES.

The negative polarity scan voltage generator 351 may generate a negative polarity scan voltage Vsc1 during an address period ADR, and may apply the negative polarity scan voltage Vsc1 to the plasma display panel 305. Accordingly, during the address period ADR, the scan signal PY may fall to the negative polarity scan voltage Vsc1.

The positive polarity scan voltage generator 371 may generate a positive polarity scan voltage Vsch during the address period ADR, and may apply the positive polarity scan voltage Vsch to the plasma display panel 305. Accordingly, during the address period ADR, the scan signal PY may rise to a positive polarity scan voltage Vsch.

The output unit 361 may include, e.g., an N channel MOSFETs 363 and 365.

The N channel MOSFET 363 may control the application of the positive polarity scan voltage Vsch output from the positive polarity scan voltage generator 371 to the plasma display panel 305. The N channel MOSFET 365 may control the application of signals output from the rising ramp waveform generator 311, the energy recovery unit 321, the falling ramp waveform generator 341, and the negative polarity scan voltage generator 351 to the plasma display panel 305.

As described above, since the block unit 313 is included between the rising ramp waveform generator 311 and the second set up voltage source 315, a large potential difference does not occur between the node N1 and the node N2. A small potential difference that may occur between the node N1 and the node N2 does not generate a large amount of heat. Accordingly, electronic devices included in the rising ramp waveform generator 311 may be safely operated with reduced influence of heat.

The operation of the scan electrode driver 301 of FIG. 1 will now be described with reference to FIG. 2. The scan signal PY may be divided into three periods, that is, e.g., the reset period RES, the address period ADR, and the sustain period SUS.

The reset period RES may be divided into a set up period SU and a set down period SD. The rising ramp waveform 411 may be generated during the set up period SU. The rising ramp waveform 411 may rise first to the first set up voltage Vs1, and then, may rise to a rising ramp voltage Vset. The rising ramp voltage Vset is a sum of the first set up voltage Vs1 and the second set up voltage Vs2. The falling ramp waveform 415 may be generated during the set down period SD.

During the set up period SU, the energy recovery unit 321 may first output the first set up voltage Vs1 and may apply the first set up voltage Vs1 to the plasma display panel 305. Thus, the rising ramp waveform 411 may rise to the first set up voltage Vs1. At this point, the N channel MOSFET included in the switching unit 331 and the N channel MOSFET 365 included in the output unit 361 may be turned on, and the N channel MOSFET 363 included in the output unit 361 may be turned off. Next, the rising ramp waveform generator 311 may apply the second set up voltage Vs2 to the plasma display panel 305. Thus, the rising ramp waveform 411 may rise to the rising ramp voltage Vset. During the set down period SD, the N channel MOSFET included in the switching unit 331 may be turned off, and the falling ramp waveform generator 341 may apply the set down voltage Vy to the plasma display panel 305, Thus, the falling ramp waveform 415 may be generated.

During an early stage of the address period ADR, the N channel MOSFET 365 included in the output unit 361 may be turned off, and the N channel MOSFET 363 included in the output unit 361 may be turned on. In this state, the positive polarity scan voltage generator 371 may output the positive polarity scan voltage Vsch and may apply the positive polarity scan voltage Vsch to the plasma display panel 305. Thus, the scan signal PY may rise to the positive polarity scan voltage Vsch. Afterwards, the N channel MOSFET 363 included in the output unit 361 may be turned off, and the N channel MOSFET 365 included in the output unit 361 may be turned on. In this state, the negative polarity scan voltage generator 351 may output the negative polarity scan voltage Vsc1 and may apply the negative polarity scan voltage Vsc1 to the plasma display panel 305, Thus, a scan pulse may be generated. After a short period of time, the N channel MOSFET 365 included in the output unit 361 may be turned off, and the N channel MOSFET 363 included in the output unit 361 may be turned on. In this state, the positive polarity scan voltage generator 371 may output the positive polarity scan voltage Vsch and may apply the positive polarity scan voltage Vsch to the plasma display panel 305. Thus, the scan signal PY may rise again to the positive polarity scan voltage Vsc1.

During the sustain period SUS, the N channel MOSFET included in the switching unit 331 and the N channel MOSFET 365 included in the output unit 361 may be turned on, and the N channel MOSFET 363 included in the output unit 361 may be turned off. In this state, the energy recovery unit 321 may alternately output a sustain voltage Vs1 and a ground voltage Vg, and may apply the sustain voltage Vs1 and the ground voltage Vg to the plasma display panel 305. Thus, the sustain pulses 431 may be generated.

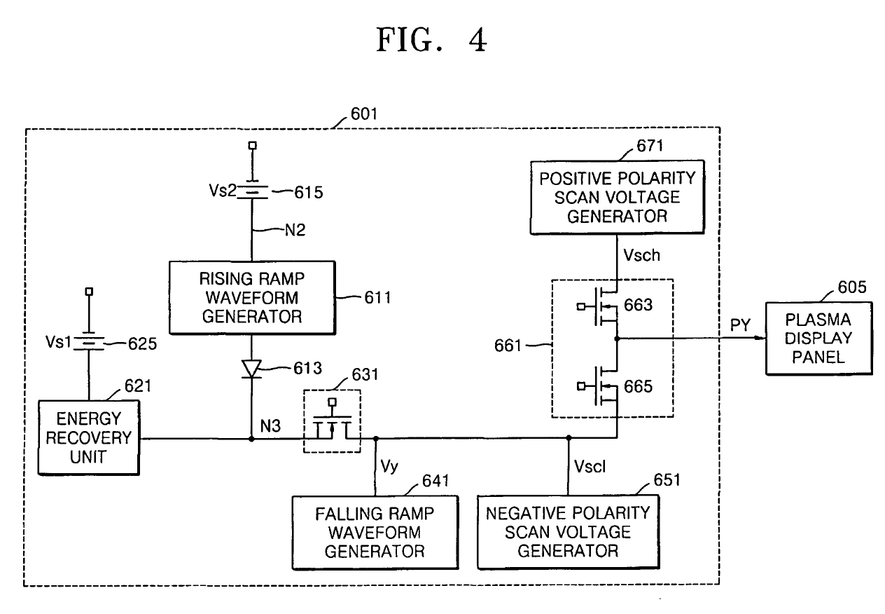

FIG. 3 is an exemplary circuit diagram of the rising ramp waveform generator 311 of FIG. 1, according to an exemplary embodiment of the present invention. Referring to FIG. 3, the rising ramp waveform generator 311 may include an N channel MOSFET 511, a gate driver 521, a plurality of resistances 531 through 534, a plurality of diodes 541 through 543, and a capacitor 551. The resistances 531 through 534 may be, e.g., a resistor and/or a transistor.

A voltage output from the gate driver 521 may be applied to a gate of the N channel MOSFET 511 through the resistance 533 to turn on the N channel MOSFET 511. When the N channel MOSFET 511 is on, a voltage output from the second set up voltage source 315 may be transmitted to the node N1 through the N channel MOSFET 511.

When the N channel MOSFET 511 is off, the voltage of the node N1 may be applied to the resistances 531 and 532 and the diode 541 through the resistance 534, the diode 543, and the capacitor 551.

The resistances 531 and 532 and the capacitor 551 may determine a rising slope of the rising ramp waveform 411. Therefore, if the resistances 531 and 532 do not operate stably, the rising slope of the rising ramp waveform 411 is not constant. If the rising slope of the rising ramp waveform 411 is not constant, the operations of scan electrodes included in the plasma display panel 305 may become unstable, resulting in an unstable image being displayed on the plasma display panel 305.

However, in embodiments, the block unit 313 is included in the scan electrode driver 301 so that the voltage of the node N1 may be applied to the resistances 531 and 532. When the voltage of the node N1 is applied to the resistances 531 and 532, a potential difference between the resistances 531 and 532 is relatively small. Accordingly, a reduced or a relatively small amount of heat may be generated by the resistances 531 and 532 because a relatively small amount of or substantially no current may flow through the resistances 531 and 532. As a result, the resistances 531 and 532 may continue to operate stably, and thus, the rising slope of the rising ramp waveform 411 may be maintained constant. In some embodiments, the resistances 531 and 532 may be configured as one unit.

FIG. 4 illustrates a block diagram of a scan electrode driver 601, according to another exemplary embodiment of the present invention, connected to a plasma display panel 605 of a plasma display device.

Referring to FIG. 4, the scan electrode driver 601 may include first and second set up voltage sources 625 and 615, a rising ramp waveform generator 611, a block unit 613, an energy recovery unit 621, a switching unit 631, a falling ramp waveform generator 641, a negative polarity scan voltage generator 651, a positive polarity scan voltage generator 671, and an output unit 661. The first and second set up voltage sources 625 and 615, the rising ramp waveform generator 611, the block unit 613, the energy recovery unit 621, the switching unit 631, the falling ramp waveform generator 641, the negative polarity scan voltage generator 651, the positive polarity scan voltage generator 671, and the output unit 661 may have identical configurations and operations as that of the first and second set up voltage sources 325 and 315, the rising ramp waveform generator 311, the block unit 313, the energy recovery unit 321, the switching unit 331, the falling ramp waveform generator 341, the negative polarity scan voltage generator 351, the positive polarity scan voltage generator 371, and the output unit 361 of FIG. 1, respectively. Thus, the detailed descriptions thereof will not be repeated. However, in the second exemplary embodiment, the location of the block unit 613 in FIG. 4 differs from that of the block unit 313 in FIG. 1. Thus, only the block unit 613 will now be described.

The block unit 613 may be arranged between the rising ramp waveform generator 611 and a node N3. The block unit 613 may include a diode having an anode that is connected to the rising ramp waveform generator 611 and a cathode that is connected to the node N3. In some embodiments, the block unit 613 may include a MOSFET instead of the diode. The block unit 613 may block the flow of a current from the rising ramp waveform generator 611 to the node N3.

In embodiments, by providing the block unit 613 between the rising ramp waveform generator 611 and the node N3, an affect of a voltage of the node N3 on the rising ramp waveform generator 611 may be reduced and/or eliminated. Accordingly, electronic devices included in the rising ramp waveform generator 611 may operate stably. That is, a large potential difference may not be generated between the resistances 531 and 532 (refer to FIG. 3) included in the rising ramp waveform generator 611. Thus, the resistances 531 and 532 may operate stably. When the resistances 531 and 532 operate stably, the rising slope of the rising ramp waveform 411 may be constant. As a result, the operation of the scan electrode driver 601 may be stable. Stable operation of the scan electrode driver 601 allows the plasma display panel 605 to display a stable motion picture.

As described above, in embodiments of the present invention, since the block unit 313 is located between the rising ramp waveform generator 311 and the second set up voltage source 315 of the scan electrode driver 301, or the block unit 613 is located between the rising ramp waveform generator 611 and the node N3 of the scan electrode driver 601, a small potential difference or substantially no potential difference may be generated in the electronic devices included in the rising ramp waveform generators 311 and 611, that is, e.g., in the resistances 531 and 532 that determine the rising slope of the rising ramp waveform 411, and accordingly, the resistances 531 and 532 may operate stably.

As a result, the rising slope of the rising ramp waveform 411 generated from the rising ramp waveform generators 311 and 611 may be constant, and thereby a stable image may be displayed on the plasma display panels 305 and 605.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A scan electrode driver for a plasma display device, the scan electrode driver supplying a rising ramp waveform to a plurality of scan electrodes of a plasma display panel, the scan electrode driver comprising:
a set up voltage source adapted to output a set up voltage;
a rising ramp waveform generator adapted to generate a rising ramp waveform in response to the set up voltage received from the set up voltage source and apply the rising ramp waveform to the plasma display panel; and
a block unit arranged between the rising ramp waveform generator and one of the set up voltage source and the plasma display panel.

2. The scan electrode driver as claimed in claim 1, wherein the block unit is arranged between the rising ramp waveform generator and the set up voltage source, is directly connected to the rising ramp waveform generator, and is adapted to controllably block current flow from the rising ramp waveform generator to the set up voltage source.

3. The scan electrode driver as claimed in claim 2, wherein the block unit includes a diode having an anode connected to the set up voltage source and a cathode connected to the rising ramp waveform generator.

4. The scan electrode driver as claimed in claim 2, wherein the rising ramp waveform generator comprises:
a gate driver adapted to output a voltage of a predetermined level;
a transistor having a drain connected to the block unit, a gate connected to the gate driver, and a source that outputs the rising ramp waveform;
a resistance unit connected to the block unit; and
a capacitor connected to the resistance unit and the transistor, and determines a rising slope of the rising ramp waveform together with the resistance unit.

5. The scan electrode driver as claimed in claim 4, wherein the resistance unit is at least one of a diode and a transistor.

6. The scan electrode driver as claimed in claim 4, wherein the transistor is an N channel MOSFET that is operated when a voltage applied to the gate is higher than a voltage applied to the source.

7. The scan electrode driver as claimed in claim 2, wherein the scan electrode driver further comprises an energy recovery unit connected to an output unit of the rising ramp waveform generator and adapted to generate a medium voltage of the rising ramp waveform.

8. The scan electrode driver as claimed in claim 7, wherein the energy recovery unit is adapted to generate the medium voltage of the rising ramp waveform in response to a voltage received from the set up voltage source connected to the rising ramp waveform generator.

9. The scan electrode driver as claimed in claim 3, wherein the block unit is a diode.

10. The scan electrode driver as claimed in claim 1, wherein the block unit is arranged between the rising ramp waveform generator and the plasma display panel, and is adapted to controllably block current flow due to an externally supplied voltage to a node between the block unit and the plasma display panel.

11. The scan electrode driver as claimed in claim 10, wherein the block unit includes a diode having an anode connected to the output unit of the rising ramp waveform generator and a cathode connected to the node.

12. The scan electrode driver as claimed in claim 11, wherein the block unit is a diode.

13. The scan electrode driver as claimed in claim 10, wherein the rising ramp waveform generator comprises:
a gate driver adapted to output a voltage of a predetermined level;
a transistor having a drain connected to the set up voltage source, a gate connected to the gate driver, and a source that outputs the rising ramp waveform;
a resistance unit connected to the set up voltage source; and
a capacitor connected to the resistance unit and the MOSFET, and determines the rising slope of the rising ramp waveform together with the resistance unit.

14. The scan electrode driver as claimed in claim 13, wherein the resistance unit is at least one of a diode and a transistor.

15. The scan electrode driver as claimed in claim 13, wherein the transistor is an N channel MOSFET that is operated when a voltage applied to the gate is higher than a voltage applied to the source.

16. The scan electrode driver as claimed in claim 13, wherein the scan electrode driver further comprises an energy recovery unit connected to the node and generates a medium voltage of the rising ramp waveform.

17. The scan electrode driver as claimed in claim 16, wherein the energy recovery unit is adapted to generate the medium voltage of the rising ramp waveform in response to a voltage received from the set up voltage source connected to the rising ramp waveform generator.

18. A scan electrode driver for a plasma display device, the scan electrode driver supplying a rising ramp waveform to a plurality of scan electrodes of a plasma display panel, the scan electrode driver comprising:
a set up voltage source adapted to output a set up voltage;
a rising ramp waveform generator adapted to generate and output a rising ramp waveform at a first terminal thereof in response to the set up voltage supplied to a second terminal of the rising ramp waveform generator from the set up voltage source and apply the rising ramp waveform to the plasma display panel; and
a potential difference reducing means for reducing a potential difference between the first terminal and the second terminal of the rising ramp waveform generator.

19. The scan electrode driver as claimed in claim 18, wherein the potential difference reducing means includes a diode directly connected to at least one of the first terminal and the second terminal of the rising ramp waveform generator.

20. The scan electrode driver as claimed in claim 18, wherein the potential difference reducing means is a diode directly connected to at least one of the first terminal and the second terminal of the rising ramp waveform generator.
